(19) United States
(12) Patent Application Publication
(10) Pub. No.: US 2025/0237305 A1
(43) Pub. Date: Jul. 24, 2025

(54) SYSTEM AND METHOD FOR SHIFTING GEARS

(71) Applicant: Dana Limited, Maumee, OH (US)

(72) Inventors: Nicolas LENAERTS, Brugge (BE); Christophe DE BUYSER, Veldegem (BE); Kevin VYNCKE, Brugge (BE); Pieterjan Jozef M. COOREMAN, Brugge (BE); Laurens DE BRUYNE, Middelkerke (BE)

(21) Appl. No.: 18/969,625

(22) Filed: Dec. 5, 2024

Related U.S. Application Data
(60) Provisional application No. 63/622,756, filed on Jan. 19, 2024.

(51) Int. Cl. F16H 61/04; F16H 59/36; F16H 61/02; F16H 63/50

(52) U.S. Cl. CPC F16H 61/0403; F16H 61/0213; F16H 61/0437; F16H 63/502; F16H 59/36; F16H 2061/0422

(57) ABSTRACT

A method and system for shifting gears of a converter-less transmission of a vehicle is described. In one example, torque output of a torque source is adjusted to synchronize input and output speeds of a gear clutch while a pressure of the gear clutch is adjusted to provide a desired or requested transmission output torque.

### CROSS REFERENCE TO RELATED APPLICATION

The present application claims priority to U.S. Provisional Application No. 63/622,756, entitled “SYSTEM AND METHOD FOR SHIFTING GEARS”, and filed on Jan. 19, 2024. The entire contents of the above-listed application are hereby incorporated by reference for all purposes.

### TECHNICAL FIELD

The present disclosure relates to controlling gear shifting of an automatic transmission. The automatic transmission may include an electric machine as a propulsion source.

### BACKGROUND AND SUMMARY

A vehicle may include a transmission so that torque sources (e.g., internal combustion engines and electric machines) may be operated in their most efficient operating regions at different vehicle speeds. The transmission may include a torque converter to dampen driveline torque disturbances. The driveline torque disturbances that may occur during transmission gear shifting and during abrupt driver demand changes. Additionally, the torque converter may provide torque multiplication during some operating conditions. However, the torque converter may reduce driveline efficiency. Therefore, it may be desirable to manufacture a torque converter-less driveline with a transmission that shifts smoothly.

The inventors herein have recognized the above-mentioned issues and have developed a method for shifting gears of a transmission, comprising: via a controller, adjusting output of a torque source to synchronize an input speed of a clutch to an output speed of the clutch while adjusting a torque capacity of the clutch to generate a requested transmission torque output during a gear shift of the transmission.

By adjusting torque output of a torque source to synchronize input speed and output speed of a gear clutch during shifting while adjusting torque of a clutch (e.g., an amount of torque that the clutch may transfer at a present clutch pressure) to generate a requested transmission torque output, it may be possible to provide the technical result of generating smooth transmission output torque during a transmission gear shift. The torque output of the torque source may be adjusted so that the clutch input speed matches clutch output speed during a speed synchronization phase of the gear shift and torque capacity of the clutch is adjusted during the gear shift so that the clutch transmits a requested transmission output torque. Consequently, a smooth and continuous transmission output torque may be generated.

The present description may provide several advantages. In particular, the approach may reduce driveline torque disturbances. Further, the approach may result in efficient driveline operation. In addition, the approach may be applied to different types and configurations of transmissions.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not constrained to implementations that solve any disadvantages noted above or in any part of this disclosure.

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to constrain the scope of the present disclosure in any way.

### BRIEF DESCRIPTION OF THE FIGURES

FIG. 1 is a schematic diagram of an example vehicle powertrain that includes a transmission;

FIGS. 2-4 show diagrams of example transmissions;

FIGS. 5 and 6 show example shifting sequences for the system of FIGS. 1-4 according to the method of FIGS. 7 and 8;

FIGS. 7 and 8 show method for shifting a transmission of a vehicle; and

FIG. 9 shows a transmission stick diagram for one example transmission.

### DETAILED DESCRIPTION

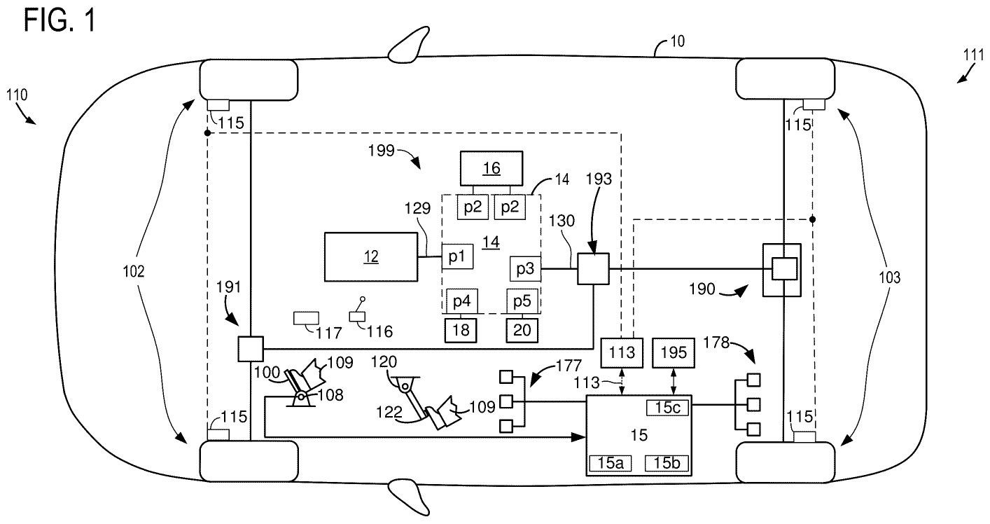

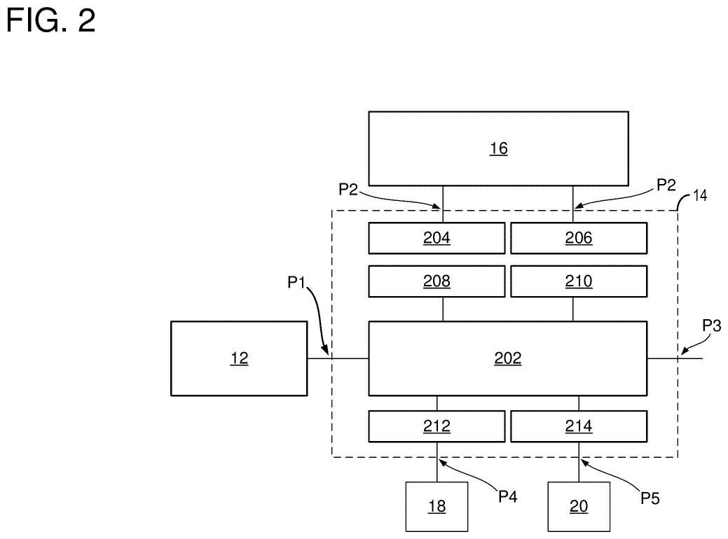

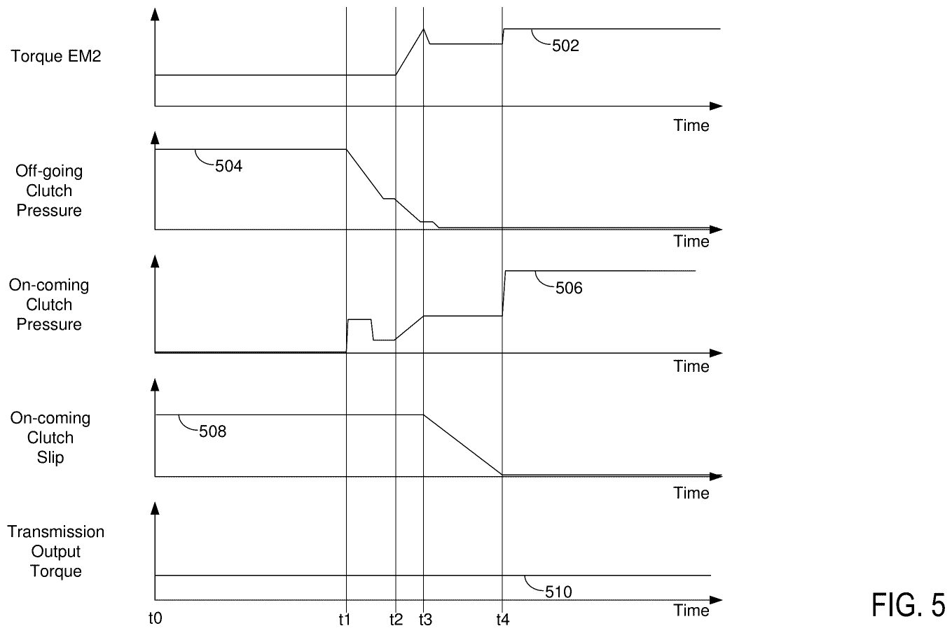

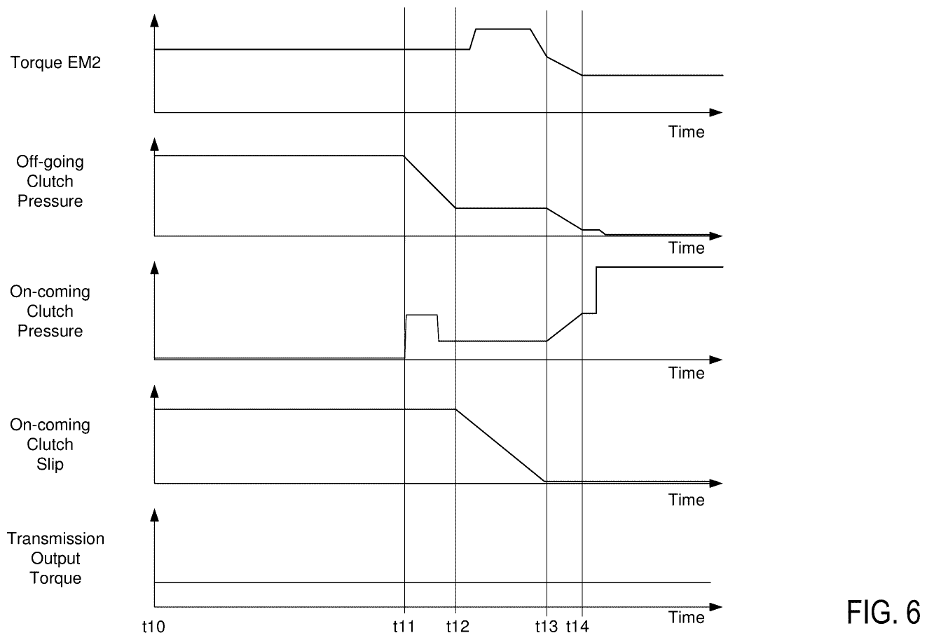

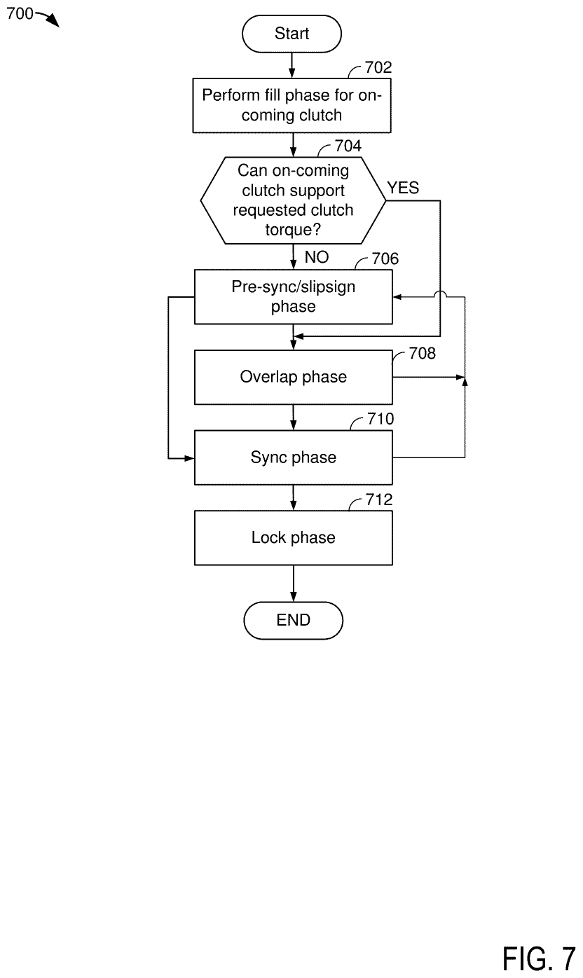

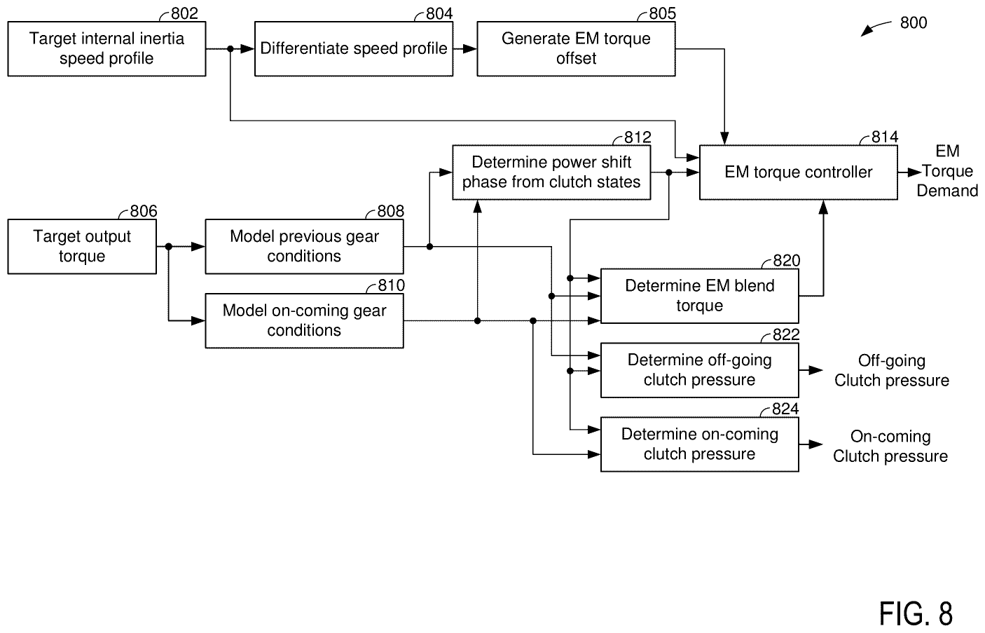

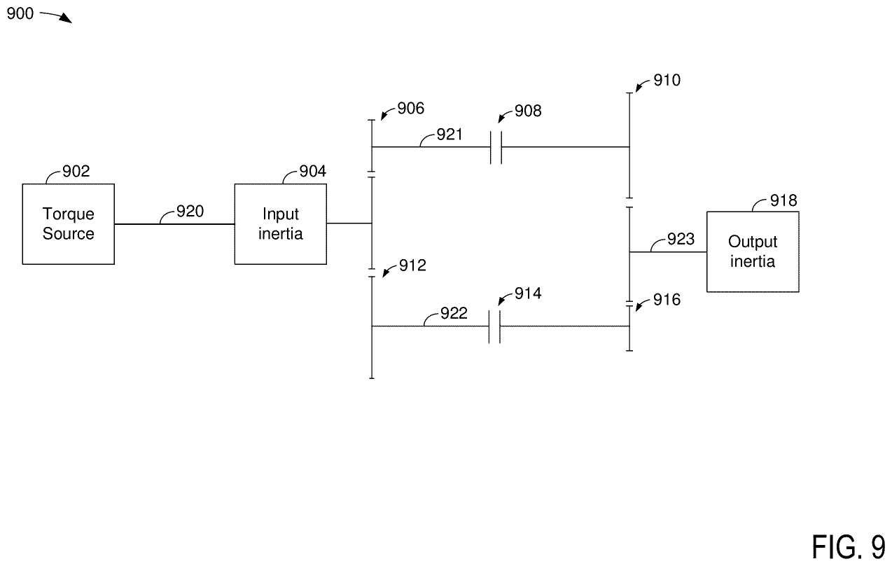

The following description relates to systems and methods for shifting a transmission of a vehicle. The vehicle may include one or more torque sources to propel the vehicle. In one example, the vehicle may include an electric machine torque source. The vehicle may be an electric vehicle, a hybrid vehicle, or a vehicle that has an internal combustion engine as it sole motive power source. In one example, the vehicle may be a four-wheel drive vehicle as shown in FIG. 1. The vehicle may include a transmission that is configured as shown in FIGS. 2-4, or alternatively, the transmission may be of a different configuration. The transmission may be shifted from a first gear to a second gear as shown in FIGS. 5 and 6 according to vehicle operating conditions. The vehicle may be operated according to the method of FIGS. 7 and 8. The vehicle may have a transmission as shown in FIG. 9.

FIG. 1 illustrates an example vehicle powertrain 199 included in vehicle 10. Vehicle 10 includes a front side 110 and a rear side 111. Vehicle 10 includes front wheels 102 and rear wheels 103. Vehicle 10 includes a torque source 12 (e.g., internal combustion engine or electric machine) that may selectively provide propulsive effort to front axle 191 and rear axle 190. In other examples, the torque source 12 may provide propulsive effort solely to front axle 191 or solely to rear axle 190. Torque source 12 is shown mechanically coupled to transmission 14 via transmission input shaft 129. In some examples, the engine's crankshaft (not shown) may be coupled to transmission input shaft 129. Transfer case 193 routes mechanical power from transmission output shaft 130 to front axle 191 and rear axle 190. A vehicle operator may select a particular transmission gear or vehicle operating mode via shifter 116. The vehicle's angle relative to horizontal ground may be determined via inclinometer 117.

Electric energy storage device 16 (e.g., a traction battery or capacitor) may provide electric power to electric machines included in transmission 14. Transmission 14 may supply mechanical power to mechanically driven accessories 18 and 20. Transmission 14 may be operated via controller 15. In this example, controller 15 is configured to command electric machines (not shown), clutches (not shown), and brakes (not shown) within transmission 14. Controller 15 may switch operating modes of transmission 14 via adjusting states of clutches and brakes. Controller 15 may also receive a position of a driver demand pedal 100 from driver demand pedal position sensor 108, which may be an input for determining the operating state of transmission 14. The driver demand pedal 100 and the driver demand pedal position sensor 108 may react to movement caused by human driver 109. Brake pedal 122 may be applied by human driver 109 and brake pedal sensor 120 provides an indication of brake pedal position to controller 15. Controller 15 may receive data from sensors 177. Sensors 177 may include, but are not constrained to a vehicle speed sensor, a transmission temperature sensor, transmission input shaft speed sensor, transmission output shaft speed sensor, wheel speed sensors, an inclinometer, and a shifter position sensor, and an ambient temperature sensor. Controller 15 may adjust operating states of the vehicle powertrain 199 via adjusting operating states of actuators 178. Actuators 178 may include but are not constrained to electric machines, inverters, clutch actuators for clutches (C0-C2), brake actuators for brakes (mid brake B1/low brake B2), and engine torque actuators (throttle, cams, fuel injectors, spark actuator). Controller 15 includes a processor 15a for executing instructions, read-exclusive memory 15b, and random access memory 15c. In this example, a single controller 15 is shown, but in other examples several controllers may operate together in a distributed system to perform the methods described herein. Controller 15 may receive input from and provide output to human/machine interface 195 (e.g., touch screen display, pushbuttons, etc.). Controller 15 may also communicate with friction brake controller 113 via controller area network 113. Friction brake controller 113 may selectively apply and release friction brakes 115 in coordination with instructions received from controller 15. Alternatively, additional or fewer controllers may be provided.

Referring now to FIG. 2, a block diagram of transmission 14 is shown. Transmission 14 is shown with 5 ports that are labeled P1-P5. Port 1 (P1) is configured to receive mechanical energy from torque source 12 (e.g., internal combustion engine or electric machine). Alternatively, port 1 may deliver mechanical energy to external power source 12. Port 2 (P2) is a port that receives electrical power from electric energy storage device 16. Alternatively, port 2 may provide electrical power to electric energy storage device 1. Electrical ports 2 are shown directly electrically coupled to a first inverter 206 and a second inverter 204. First inverter 206 may convert direct current (DC) to alternating current (AC). AC may be delivered from first inverter 206 to first electric machine 210. Likewise, AC may be delivered from second inverter 204 to second electric machine 208. Alternatively, first and second electric machines 210 and 208 may deliver AC power to inverters 206 and 204. Electric machines 210 and 208 may supply mechanical power to gears, clutches, and brakes 202. As such, electric machines 210 and 208 may also be referred to as torque sources. Gears, clutches, and brakes 202 may transfer mechanical power to output ports P3-P5. Output port P3 may transfer mechanical power to wheels 103. Output port P4 may transfer mechanical power to power take off (PTO1) 212 and accessories 18, the accessories 18 not including vehicle wheels. Output port P5 may transfer mechanical power to power take off (PTO2) 214 and accessories 20, the accessories 20 not including vehicle wheels.

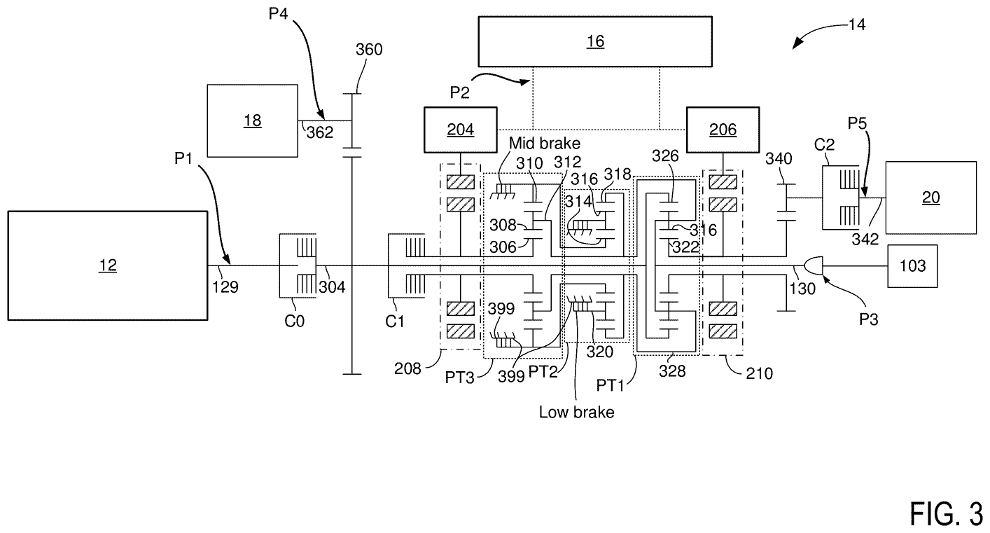

Turning now to FIG. 3, a detailed view of one example of transmission 14 is shown. In this example, torque source 12 is shown coupled to transmission input shaft 129. Transmission input shaft 129 is coupled to clutch C0 and clutch C0 may selectively couple transmission input shaft 129 to connecting shaft 304. Clutch C0 is directly coupled to ring gear 326 of first planetary gear set PT1 and PTO1 gear 360 via connecting shaft 304. PTO1 gear 360 may be coupled to accessories 18 via PTO1 shaft 362. First planetary gear set PT1 also includes planetary gears 316 and a sun gear 322. Sun gear 322 is shown coupled to PTO2 gear 340 and electric machine 210. Planetary gears 316 couple sun gear 322 to ring gear 326. Carrier 328 supports planetary gears 316. PTO2 gear 340 may be selectively coupled to PTO2 output shaft 342 via PTO2 clutch C2. PTO2 output shaft 342 may be directly coupled to accessories 20, and accessories 20 are not coupled to vehicle wheels.

Connecting shaft 304 may be selectively coupled to electric machine 208 and sun gear 306 of third planetary gear set PT3 via closing input coupled clutch C1. Sun gear 306 of third planetary gear set PT3 is coupled to planetary gears 308. Planetary gears 308 are coupled to ring gear 310, and planetary gears 308 are supported via carrier 312. Planetary gears 308 are coupled to ring gear 318 of second planetary gear set PT2 and planetary gears 316 of first planetary gear set PT1 via carrier 312 of third planetary gear set PT3 and carrier 328 of first planetary gear set PT1. Carrier 328 of first planetary gear set PT1 is coupled to wheels 103 via transmission output shaft 130. Mid brake B1 may be closed to ground or couple ring gear 310 of third planetary gear set PT3 to transmission case 399.

Second planetary gear set PT2 includes a sun gear 314 that is coupled to ring gear 310 of first planetary gear set PT1. Planetary gears 308 of second planetary gear set PT2 are coupled to sun gear 314 of planetary gear set PT2 and ring gear 318 of second planetary gear set PT2. Brake B2 may be closed to ground or couple carrier 320 of second planetary gear set PT2 to transmission case 399.

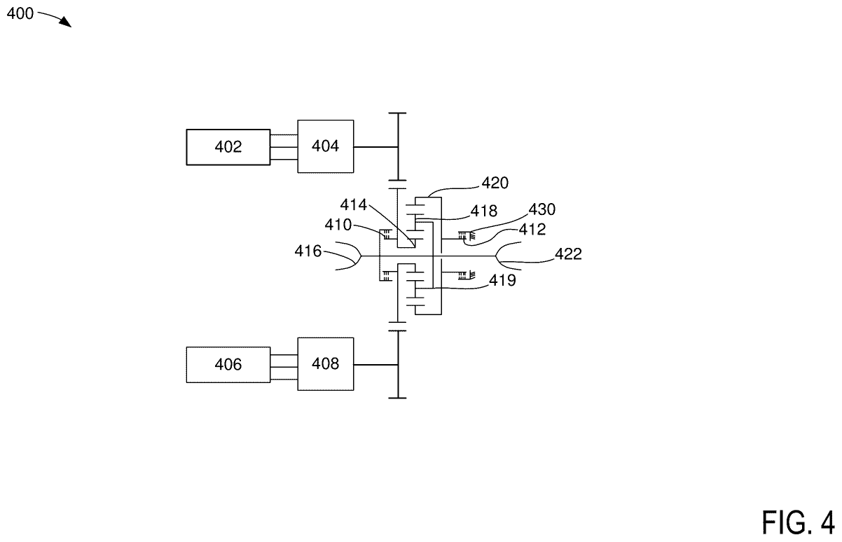

PTO1 is directly coupled to connecting shaft 304. Therefore, whenever connecting shaft 304 is rotating, PTO1 output shaft 362 rotates. PTO1 output shaft 362 may be rotated via closing clutch C0 when torque source 12 is rotating. PTO1 may also be rotated via electric machine 208 by closing clutch C1. PTO1 may rotate in any of the modes that are shown in the table of FIG. 4.

PTO2 may rotate and provide mechanical power to accessories 20 during three modes. In a hill hold mode, brakes mid brake B1 and low brake B2 may be closed to lock rotation of transmission output shaft 130 and PTO2 output shaft 342 may be rotated via torque generated via electric machine 210 and/or torque source 12. In this way, PTO2 output shaft 342 may rotate at a speed that is a multiple of a rotational speed of torque source 12 and connecting shaft 304.

PTO2 output shaft 342 may be rotated when clutch C1 is open, C2 is closed, and C0 is open or closed. PTO2 output shaft 342 may also provide mechanical torque to accessories 20 when brake mid brake B1 is open, low brake B2 is closed, C1 is open, C2 is closed and C0 is open or closed. Applying brake B2 prevents rotation of carrier 320 so that when torque source 12 or electric machine 208 drive the transmission output shaft 130 via connecting shaft 304, second planetary gear set PT2, and first planetary gear set PT1, PTO2 gear 340 may rotate. Energy may flow from torque source 12 to connecting shaft 304 via clutch C0, connecting shaft 304 may transfer torque to ring gear 326 causing planetary gears 316 to rotate along with sun gear 322 so that carrier 328 and transmission output shaft 130 may rotate. Rotating sun gear 322 allows PTO2 gear 340 to rotate. PTO2 output shaft 342 may rotate when clutch C2 is closed.

PTO2 output shaft 342 may also be rotated when clutch C1 is open, C2 is closed, and C0 is open or closed. PTO2 output shaft 342 may also provide mechanical torque to accessories 20 when brake mid brake B1 is closed, low brake B2 is open, C1 is open, C2 is closed and C0 is open or closed. Applying brake mid brake B1 prevents rotation of ring gear 310 and sun gear 306. Energy may flow from torque source 12 to connecting shaft 304 via clutch C0, connecting shaft 304 may transfer torque to ring gear 326 causing planetary gears 316 to rotate along with sun gear 322 so that carrier 328 and transmission output shaft 130 may rotate. Rotating sun gear 322 allows PTO2 gear 340 to rotate. PTO2 output shaft 342 may rotate when clutch C2 is closed.

Referring now to FIG. 4, one of several alternative transmission configurations that may benefit from the method disclosed herein is shown. Transmission 400 includes a first inverter 402 and a second inverter 406. First inverter 402 is directly electrically coupled to first electric machine 404. Second inverter 406 is directly electrically coupled to second electric machine 408. First electric machine 404 and second electric machine 408 may be powered by electric energy storage device 16 as shown in FIG. 1. In this example, controller 15 (e.g., as shown in FIG. 1) is configured to command first electric machine 404, second electric machine 408, a first clutch 410, and a first brake 412. The controller may switch operating modes of transmission 400 via adjusting states of clutches and brakes.

Transmission 400 includes a rear output shaft 416 and a front output shaft 422. Transmission also includes a planetary gear set 413 that includes a sun gear 414, planetary gears 418, carrier 419 that supports the planetary gears, and ring gear 420. First brake 412 may selectively couple ring gear 420 to transmission case 430. Rear output shaft 416 and front output shaft 422 are coupled to carrier 419 and first clutch 410. First clutch 410 may be closed to couple front output shaft 416 and rear output shaft 422 to sun gear 414, first electric machine 404 and second electric machine 408. Output shaft 422 and input shaft 416 may be locked by applying clutch 410 and first brake 412.

Thus the systems of FIGS. 1-4 may provide for a vehicle system, comprising: one or more torque sources; a transmission including a plurality of gear clutches and gears; a controller including executable instructions that cause the controller to adjust a torque output of the torque source to synchronize an input speed of a clutch included in the plurality of gear clutches with an output speed of the clutch while adjusting a pressure applied to the clutch to adjust an output torque of the transmission during a speed synchronization phase of a transmission gear shift. In a first example, the vehicle system includes where the torque source is an electric machine. In a second example that may include the first example, the vehicle system includes where the speed synchronization phase of the transmission gear shift is prior to a torque transfer phase of the transmission gear shift. In a third example that may include one or both of the first and second examples, the vehicle system includes where the speed synchronization phase of the transmission gear shift follows a torque transfer phase of the transmission gear shift. In a fourth example that may include one or more of the first through third examples, the vehicle system includes where the torque output of the torque source is adjusted based on a torque transferred via the clutch. In a fifth example that may include one or more of the first through fourth examples, the vehicle system includes where the output torque of the transmission is adjustable. In a sixth example that may include one or more of the first through fifth examples, the vehicle system includes where the pressure of the clutch is adjusted to generate a clutch torque that is equal to the target output torque of the transmission divided by a gear ratio of a respective active gear.

Referring now to FIG. 5, a prophetic power-on (e.g., positive powertrain power is requested) transmission gear upshift (e.g., a shift from 1^{st} gear to 2^{nd} gear) sequence according to the method of FIGS. 7 and 8 is shown. The sequence of FIG. 5 may be provided by the systems of FIGS. 1-4 in cooperation with the method of FIGS. 7 and 8. The plots of FIG. 5 are time aligned. The sequence of FIG. 5 may be generated via the transmission of FIG. 3. The second electric machine is providing torque to propel the vehicle in the sequence of FIG. 5.

The first plot from the top of FIG. 5 is a plot of torque output of second electric machine 208 (EM2) of FIG. 2 versus time. The vertical axis represents torque and the torque value increases in the direction of the vertical axis arrow. The horizontal axis represents time and time increases from the left side of the figure to the right side of the figure. Trace 502 represents torque output of the second electric machine.

The second plot from the top of FIG. 5 is a plot of off-going clutch pressure (e.g., pressure of fluid (e.g., oil) within the off-going clutch) versus time. The vertical axis represents off-going clutch pressure and the off-going clutch pressure increases in the direction of the vertical axis arrow. The horizontal axis represents time and time increases from the left side of the figure to the right side of the figure. Trace 504 represents off-going clutch pressure.

The third plot from the top of FIG. 5 is a plot of on-coming clutch pressure (e.g., pressure of fluid (e.g., oil) within the on-coming clutch) versus time. The vertical axis represents on-coming clutch pressure and the on-coming clutch pressure increases in the direction of the vertical axis arrow. The horizontal axis represents time and time increases from the left side of the figure to the right side of the figure. Trace 506 represents on-coming clutch pressure.

The fourth plot from the top of FIG. 5 is a plot of on-coming clutch slip (e.g., output side of on-coming clutch speed minus input side of on-coming clutch speed in units of revolutions/minute (RPM)) versus time. The vertical axis represents on-coming clutch slip in units of RPM. The horizontal axis represents time and time increases from the left side of the figure to the right side of the figure. Trace 508 represents on-coming clutch slip.

The fifth plot from the top of FIG. 5 is a plot of transmission output torque versus time. The vertical axis represents transmission output torque. Transmission output shaft torque increases in a direction of the vertical axis arrow. The horizontal axis represents time and time increases from the left side of the figure to the right side of the figure. Trace 510 represents transmission output shaft torque.

At time t0, the transmission in a pre-shift phase before onset of a transmission gear shift. The electric machine torque is at a medium level and the off-going clutch pressure is high. The on-coming clutch pressure is zero and the on-coming clutch slip value is high. The transmission output torque is at a medium level.

At time t1, the transmission gear shift begins and the gear shift enters a clutch filling phase. The gear shift is a power-on (e.g., driver demand is positive and non-zero) upshift where the transmission shifts from a first gear with a lower ratio to a second gear with a higher ratio. The upshift begins by reducing pressure in the off-going clutch (e.g., clutch that operates the gear that is being released) and increasing pressure in the on-coming clutch (e.g., clutch that operates the gear that is being engaged). Increasing pressure in the on-coming clutch fills the on-coming clutch so that the clutch is prepared to transfer torque. The clutch is filled to counter spring pressure (also known as the “touch” pressure) and the filling is up to a point where minimal torque is transferred through the clutch and where the filling ceases. The on-coming clutch slip remains high and the transmission output torque is unchanged. Torque output of the electric machine is unchanged.

The off-going clutch pressure decrease between time t1 and time t2 does not result in a transmission output torque decrease since the off-going clutch torque capacity is greater than the clutch's torque (e.g., the torque that is applied to the clutch). During the period from time t1 to time t2, the off-going clutch pressure is decreased to a pressure where the clutch torque capacity equals the clutch torque. The off-going clutch pressure is held until the on-coming clutch's fill phase is ready. Once the on-coming clutch's fill phase is ready, the pressure of the off-going clutch may be reduced to reduce the amount of torque that is transferred through the off-going clutch.

At time t2, the transmission gear shift continues and the gear shift enters a torque transfer phase. The torque output of the electric machine begins to increase so that after the shift ends the transmission output torque is equal to the transmission output torque at the time that the shift began. Increasing the output torque of the electric machine compensates for the effect of the gear ratio change on transmission output torque. Pressure in the off-going is decreased to decrease the clutch torque. In parallel, the Pressure in the on-coming clutch is increased to increase the on-coming clutch torque. The on-coming clutch continues to slip and the transmission output torque is unchanged.

At time t3, the transmission gear shift continues and the gear shift enters a clutch speed synchronization phase. During the clutch speed synchronization phase, an input speed of one side of an on-coming clutch (e.g., input side of the on-coming clutch) is adjusted to a speed of the other side of the on-coming clutch (e.g., output side of the on-coming clutch). The torque output of the electric machine begins to be reduced so that a desired internal inertia rate of speed change may be achieved. In this example, the electric machine torque is at a substantially constant value (e.g., a value that is within ±5% of a constant requested torque for the electric machine) equal to the sum of the torque in the on-coming gear plus the torque offset to achieve the desired clutch synchronization acceleration. The on-coming clutch slip level begins to decrease and the transmission output torque is unchanged. The EM2 torque exhibits a negative torque offset between time t3 and time t4, the whole synchronization phase. This negative offset is present to allow the EM2 (and all connected inertias) to decelerate. Thus, this offset may be applied over the whole synchronization phase.

At time t4, the transmission gear shift enters an after shift phase with the on-coming clutch slip reaching a speed that is within a threshold speed of zero speed (e.g., less than 10 RPM). The acceleration torque offset is removed and the on-coming clutch pressure is increased to fully engaged the on-coming gear. At this time, pressure in the off-going clutch is reduced to zero and the transmission output torque is unchanged.

In this way, output torque of the transmission may be controlled such that it remains substantially constant through the gear shift. The electric machine torque is a sum of torque to transfer torque from a first gear to a second gear and torque to synchronize speeds on an input side of a clutch and output side of the clutch.

Referring now to FIG. 6, a prophetic power-on (e.g., positive powertrain power is requested) transmission gear downshift (e.g., a shift from 2^{nd} gear to 1^{st} gear) sequence according to the method of FIGS. 7 and 8 is shown. The sequence of FIG. 6 may be provided by the systems of FIGS. 1-4 in cooperation with the method of FIGS. 7 and 8. The plots of FIG. 6 are time aligned. The sequence of FIG. 6 may be generated via the transmission of FIG. 3. The second electric machine is providing torque to propel the vehicle in the sequence of FIG. 5.

The first plot from the top of FIG. 6 is a plot of torque output of second electric machine 208 (EM2) of FIG. 2 versus time. The vertical axis represents torque and the torque value increases in the direction of the vertical axis arrow. The horizontal axis represents time and time increases from the left side of the figure to the right side of the figure. Trace 602 represents torque output of the second electric machine.

The second plot from the top of FIG. 6 is a plot of off-going clutch pressure (e.g., pressure of fluid (e.g., oil) within the off-going clutch) versus time. The vertical axis represents off-going clutch pressure and the off-going clutch pressure increases in the direction of the vertical axis arrow. The horizontal axis represents time and time increases from the left side of the figure to the right side of the figure. Trace 604 represents off-going clutch pressure.

The third plot from the top of FIG. 6 is a plot of on-coming clutch pressure (e.g., pressure of fluid (e.g., oil) within the on-coming clutch) versus time. The vertical axis represents on-coming clutch pressure and the on-coming clutch pressure increases in the direction of the vertical axis arrow. The horizontal axis represents time and time increases from the left side of the figure to the right side of the figure. Trace 606 represents on-coming clutch pressure.

The fourth plot from the top of FIG. 6 is a plot of on-coming clutch slip (e.g., output side of on-coming clutch speed minus input side of on-coming clutch speed in units of revolutions/minute (RPM)) versus time. The vertical axis represents on-coming clutch slip in units of RPM. The horizontal axis represents time and time increases from the left side of the figure to the right side of the figure. Trace 608 represents on-coming clutch slip.

The fifth plot from the top of FIG. 6 is a plot of transmission output torque versus time. The vertical axis represents transmission output torque. Transmission output shaft torque increases in a direction of the vertical axis arrow. The horizontal axis represents time and time increases from the left side of the figure to the right side of the figure. Trace 610 represents transmission output shaft torque.

At time t10, the transmission in a pre-shift phase before onset of a transmission gear shift. The electric machine torque is at a high level and the off-going clutch pressure is high. The on-coming clutch pressure is zero and the on-coming clutch slip value is high. The transmission output torque is at a medium level.

At time t11, the transmission gear shift begins and the gear shift enters a clutch filling phase. The gear shift is a power-on (e.g., driver demand is positive and non-zero) downshift where the transmission shifts from a first gear with a higher ratio to a second gear with a lower ratio. The downshift begins by reducing pressure in the off-going clutch (e.g., clutch that operates the gear that is being released) and increasing pressure in the on-coming clutch (e.g., clutch that operates the gear that is being engaged). Increasing pressure in the on-coming clutch begins to fill the on-coming clutch. The on-coming clutch slip remains high and the transmission output torque is unchanged. Torque output of the electric machine is unchanged.

At time t12, the transmission gear shift continues and the gear shift enters a clutch speed synchronization phase. During the clutch speed synchronization phase, an input speed of one side of an on-coming clutch (e.g., input side of the on-coming clutch) is adjusted to a speed of the other side of the on-coming clutch (e.g., output side of the on-coming clutch). The torque output of the electric machine is increased a small amount and it is held substantially constant (e.g., a value that is within ±5% of a constant requested torque for the electric machine). Pressure in the off-going clutch ceases decreasing and it is held substantially constant (e.g., a value that is within +5% of a constant requested pressure for the off-going clutch). The pressure for the on-coming clutch is also held substantially constant at the “touch” pressure where torque transfer capacity through the on-coming clutch is minimal. The on-coming clutch slip level begins to decrease and the transmission output torque is unchanged.

At time t13, the transmission gear shift continues and the gear shift enters a torque transfer phase. The torque output of the electric machine begins to decrease so that after the shift ends the transmission output torque is equal to the transmission output torque at the time that the shift began. Decreasing the output torque of the electric machine compensates for the effect of the gear ratio change on transmission output torque. Pressure in the off-going clutch resumes decreasing to decrease its torque (and output torque share), and the on-coming clutch increases its pressure to increase its torque (and output torque share). The on-coming clutch slip is zero and the transmission output torque is unchanged.

At time t14, the transmission gear shift enters an after shift phase when the electric machine torque reaches its end shift torque. The off-going clutch pressure continues to decrease and the on-coming clutch pressure is increased shortly after time t14. Transmission output torque is unchanged.

In this way, output torque of the transmission may be controlled such that it remains substantially constant through the gear downshift. The electric machine torque is a sum of torque to transfer torque from a first gear to a second gear and torque to synchronize speeds on an input side of a clutch and output side of the clutch.

Referring now to FIG. 7, a method for shifting a transmission is shown. The method of FIG. 7 may be stored as executable instructions in non-transitory memory of a controller of a system as described in FIGS. 1-4. The controller may apply sensors and actuators to adjust operating states of the system according to the method of FIG. 7. The steps of method 700 may be preceded by a pre-shift phase.

Method 700 is described in terms of applying clutches, but brakes (e.g., wheel friction brakes or transmission brakes) may be applied in some embodiments instead of clutches. As such, actions of brakes may be substituted for actions of clutches. The transmission clutches may engage or disengage transmission gears based on a shift schedule that may be referenced by vehicle speed and driver demand. The on-coming clutches are closed to engage the on-coming gears (e.g., transmission gears that are going to be or are being engaged based on vehicle operating conditions). The off-going clutches are opened to disengage off-going gears (e.g., transmission gears that are going to be or are being disengaged).

At 702, method 700 begins filling an on-coming clutch via supplying fluid to fill a clutch via a clutch actuator. The on-coming clutch begins to fill so that an on-coming gear may be engaged. For an upshift, the on-coming gear is a numerically higher gear with a lower gear ratio. For example, for an upshift from 1^{st} gear to 2^{nd} gear, the 2^{nd} gear is the on-coming gear and the clutch that selectively engages the 2^{nd} gear is the on-coming clutch. Method 700 proceeds to 704.

At 704, method 700 judges whether or not the on-coming coming clutch supports the requested clutch torque. The requested clutch torque is the clutch torque that needs to pass through the on-coming clutch to provide the requested transmission output torque during the shift from the off-going gear to the on-coming gear. The decision of whether or not the on-coming clutch supports the requested clutch torque may be determined based on a clutch slip speed sign in the on-coming gear. Upshifts (e.g., shifting from a numerically lower gear 1^{st} gear to a numerically higher gear 2^{nd} gear) are shifts that often may support the requested clutch torque. Downshifts (e.g., shifting from a numerically higher gear 2^{nd} gear to a numerically lower gear) are shifts that often may not support the requested torque. However, sometimes upshifts may not support the requested clutch torque and downshifts may sometimes support the requested clutch torque capacity.

By way of a simplified example for a driveline that includes a torque source followed by an input inertia as shown in FIG. 9, where the input inertia is followed by a parallel set of 2 clutches, each clutch has their own, different, ratio from the common input shaft to the common output shaft, where the clutch set is followed by an output inertia, where a direction of torque flow is from the torque source to the vehicle wheels, the driveline may be described by the following equations:

$${T}_{in} - {a}_{input} \cdot {J}_{input} - {T}_{clutch 1 in} * R {1}_{in} - {T}_{clutch 2 in} * R {2}_{in} = 0$$

$${T}_{clutch 1 out} * R {1}_{out} + {T}_{clutch 2 out} * R {2}_{out} - {T}_{out} = 0$$

$${T}_{clutch 1 in} + {T}_{clutch 1 out} = 0$$

$${T}_{clutch 2 in} + {T}_{clutch 2 out} = 0$$

where Tᵢₙ is torque generated via a torque source, aᵢₙₚᵤₜ is acceleration of input inertia, Jᵢₙₚᵤₜ is the inertia of the input and T_{clutch1in} is the torque on the input side of the clutch 1, T_{clutch2in} is the torque on the input side of the clutch 2, T_{clutch1out} is torque on the output side of the clutch 1, T_{clutch2out} is torque on the output side of the clutch 2, R1ᵢₙ is the gear ratio between input shaft and clutch 1 input, R1ₒᵤₜ is the gear ratio between clutch 1 output and the transmission output shaft, R2ᵢₙ is the gear ratio between input shaft and clutch 2 input, R2ₒᵤₜ is the gear ratio between clutch 2 output and the transmission output shaft, and Tₒᵤₜ is the torque output of the transmission (e.g., torque at the transmission output shaft). An objective of the transmission gear shift may be to maintain torque output of the transmission from just before onset of the gearshift to the end of the gear shift. During such conditions, the transmission output torque Tₒᵤₜ may be described by the following equations:

$${T}_{out} = {T}_{ing 1} \cdot {R}_{g 1}$$

$${T}_{out} = {T}_{ing 2} \cdot {R}_{g 2}$$

where T_{ing1} is the torque input to a first gear, R_{g1} is the ratio of the first gear, T_{ing2} is torque input to the second gear, and R_{g2} is the ratio of the second gear. In this example, Tᵢₙ=T_{clutch}*Rᵢₙ and T_{clutch}=Tₒᵤₜ/Rₒᵤₜ. Therefore, the clutch torques may be determined via: T_{clutchg1}=Tout/R1ₒᵤₜ and T_{clutchg2}=Tout/R2ₒᵤₜ, where Tclutchg1 is the clutch torque when the clutch is engaging the first gear, T_{clutch2} is the clutch torque when the clutch is engaging the second gear. Note that in this example, the torque for accelerating inertias has been left out for simplification and that a slipping clutch may provide torque solely in its slip direction. The system torque equations may be solved during a shift to determine the requested clutch torque for a requested transmission output torque. The requested clutch torque sign may be compared to a clutch differential speed (e.g., clutch input side speed-clutch output side speed) sign (e.g., + or −). If the requested torque sign and the clutch differential speed sign are equal, the clutch (e.g., on-coming clutch) may support the requested torque. If the requested torque signs are not equal, the clutch (e.g., on-coming clutch) may not support the requested torque.

If method 700 judges that the on-coming clutch supports the requested clutch torque, the answer is yes and method 700 proceeds to 708. Otherwise, the answer is no and method 700 proceeds to 706.

At 706, method 700 enters the pre-synchronization/slip sign phase. At the start of this phase the off-going clutch pressure is low enough such that the clutch torque capacity exactly equals the needed clutch torque to maintain the requested output torque. Thus, any decrease in off-going clutch pressure will result in a decrease of clutch torque. Similarly, any increase in electric machine torque cannot be transferred by the off-going clutch and will instead be absorbed by the input inertia. During the pre-synchronization/slip sign phase, the rotational speed of the input side of the on-coming clutch is adjusted to the rotational speed of the output side of the on-coming clutch before torque is transferred through the on-coming clutch. The electric machine outputs torque to maintain transmission output torque just prior to beginning the shift when the transmission is fully engaged in the off-going gear. Further, the electric machine outputs additional torque to accelerate the inertia of transmission components (e.g., shafts and gears) to a speed that the transmission components will rotate when the on-coming gear is fully engaged at the end of the present gear shift. The off-going clutch pressure, and thus torque capacity, is controlled to maintain the requested transmission output torque. However, if the electric machine cannot synchronize the on-coming clutch input and output speeds, the off-going clutch pressure may be adjusted to synchronize the on-coming clutch input and output speeds. The on-coming clutch is maintained its touch pressure. Method 700 proceeds to 708 when the on-coming clutch input and output speeds are synchronized.

Additionally, method 700 may proceed to 710 and bypass 708 if on-coming clutch torque passes through zero torque (e.g., moves from a positive torque to a negative torque capacity according to the clutch slip sign). If this occurs, the requested on-coming clutch may support the requested target torque. Since the target torque is low, there is little torque to transfer and the overlap phase may be skipped.

At 708, method 700 enters an overlap phase or a torque transfer phase of the gear shift. The electric machine is commanded to provide the requested output torque Tₒᵤₜ according to the on-coming gear being fully engaged. The pressure that is supplied to the off-going clutch is reduced until there is no more torque transferred by the off-going clutch. The pressure of the on-coming clutch is increased until a requested clutch torque transfer capacity is reached. Method 700 proceeds to 710. If the on-coming clutch does not support the requested on-coming clutch torque, method 700 returns to 706.

At 710, method 700 enters a synchronization phase for synchronizing input speed of the on-coming clutch to the output speed of the on-coming clutch. The input speed of the on-coming clutch is the speed on the side of the on-coming clutch that is closest to the electric machine according to a direction of torque transfer through the on-coming clutch during the gear shift. The output speed of the on-coming clutch is the speed on the side of the on-coming clutch that is closest to the vehicle's wheels according to the direction of torque transfer through the on-coming clutch during the gear shift. During the synchronization phase, the electric machine torque is adjusted to a torque that generates the requested transmission output shaft torque by way of the torque transfer path that goes through the on-coming gear. Additionally, a torque to accelerate the internal inertia of the transmission to a rotational speed based on the rotational speed of the transmission output shaft is added to the electric machine torque. The off-going clutch pressure is held at a touch pressure (a pressure where the plates of the off-going clutch are just touching so that torque transfer through the off-going clutch is near zero). The pressure of the on-coming clutch is adjusted so that the on-coming clutch has a torque capacity that is sufficient to transfer enough torque through the on-coming gear so that the transmission output torque meets the requested transmission output torque. The requested transmission output torque may be based on driver demand torque and vehicle speed. If the electric machine fails to synchronize the rotational speed of the input side of the on-coming clutch with the rotational speed of the output side of the on-coming clutch, the pressure of the on-coming clutch may be adjusted to synchronize the input speed of the on-coming clutch with the output speed of the on-coming clutch. If the on-coming clutch does not support the requested on-coming clutch torque, method 700 returns to 706.

At 712, method 700 increases pressure in the on-coming clutch to fully engage the on-coming gear. The pressure in the off-going clutch is reduced to a minimum pressure to completely disengage the clutch. Method 700 exits.

Referring now to FIG. 8 a flowchart of a controller block diagram for the system of FIGS. 1-4 is shown. The controller of FIG. 8 may operate in cooperation with the method of FIG. 7 to generate the shifting sequences that are shown in FIGS. 5 and 6. The block diagram of FIG. 8 may be incorporated into the controller 15 of FIG. 1 as executable instructions store in non-transitory memory.

At block 802, a target rotational internal inertia speed profile for changing from a first gear (e.g., 2^{nd} gear) to a second gear (e.g., 3^{rd} gear) over an adjustable time frame is generated. The target inertial speed profile may be generated via a model or it may be retrieved from a table or function that is stored in controller memory. Block 802 outputs a rotational speed setpoint (e.g., a requested speed) for the internal inertia (e.g., gears, shafts, etc) to block 804 and block 814.

At block 804, the rotational speed set point is differentiated to generate a target rotational rate of speed change for the internal inertia. Block 804 outputs a rotational rate of speed set point (e.g., a requested rate of speed change) for the internal inertia of the transmission to block 805.

At block 805, an electric machine torque offset is generated by multiplying the target rotational acceleration rate for the internal inertia of the transmission by the transmission inertia and the torque ratio to the electric machine. Block 805 outputs a feed forward torque demand to block 814.

At block 806, a target transmission output torque is generated. In one example, the target transmission output torque may be based on driver demand pedal position and vehicle speed. The target transmission output torque may be empirically determined via driving a vehicle and adjusting torque based on driver demand pedal position to provide a requested vehicle speed and/or acceleration. In one example, block 806 references a table or function via vehicle speed and driver demand torque. The table or function outputs a target or requested torque and block 806 outputs the target torque to block 808 and block 810.

At block 808, requested or setpoints for the off-going gear are determined. Specifically, block 808 determines an electric machine torque by multiplying the target or requested transmission output torque by the ratio for the off-going gear. The off-going clutch torque is determined by multiplying the requested or target transmission output torque by the ratio between the transmission output and the off-going clutch. The on-coming clutch torque is commanded to zero. Block 808 outputs the electric machine torque and the off-going clutch torque to block 812 and block 820.

At block 810, requested or setpoints for the on-coming gear are determined. In particular, block 810 determines an electric machine torque by multiplying the target or requested transmission output torque by the ratio for the on-coming gear. The on-coming clutch torque is determined by multiplying the requested or target transmission output torque by the ratio between the transmission output and the on-coming clutch. The off-going clutch torque is commanded to zero. Block 810 outputs the electric machine torque and the on-coming clutch torque to block 812 and block 820.

At block 812, the power shift phase is determined from on-going and off-going clutch states according to the method of FIG. 7. The power shift phases (e.g., fill, pre-synchronous, synchronous, overlap, and overlap on are output from block 812 to block 814.

At block 824, on-coming clutch pressure is adjusted to a value of zero during the pre-synchronization phase of the transmission gear shift. During the overlap phase of a transmission gear shift, the on-coming clutch pressure is adjusted from a value of zero to a requested or target pressure. During the synchronous phase of the transmission gear shift, the on-coming clutch pressure is adjusted so that the on-coming clutch torque capacity follows a target or requested clutch torque. The target on-coming clutch pressure is equal to the on-coming clutch torque divided by a friction coefficient for the on-coming clutch. Block 824 commands an on-coming clutch actuator with the on-coming clutch pressure request.

At block 822, off-going clutch pressure is adjusted to a value of zero during the synchronization phase of the transmission gear shift. During the overlap phase of a transmission gear shift, the off-going clutch pressure is adjusted to a value of zero. During the pre-synchronous phase of the transmission gear shift, the off-going clutch pressure is adjusted to follow a target or requested clutch torque plus a clutch synchronization control torque (e.g., aᵢₙₚᵤₜ*_{Jinput}). The target off-going clutch pressure is equal to the off-going clutch torque divided by a friction coefficient for the off-going clutch. Block 822 commands an off-going clutch actuator with the off-going clutch pressure request.

At block 820, the electric machine blended torque is determined. During the pre-synchronous phase of the transmission gear shift, the electric machine torque is adjusted to provide the torque that was supplied to the off-going gear at the very beginning of the present gear shift of the transmission. During the overlap phase of the present transmission gear shift, the electric machine torque is blended from torque supplied to the off-going gear to a target or requested electric machine torque during the overlap time. During the synchronous phase of the present transmission gear shift, the electric machine torque is adjusted to a target gear torque. Block 820 supplies the electric machine torque to block 814.

At block 814, the electric machine torque output from block 820 is added to the feed forward electric machine torque supplied by block 805 and the result is added to a closed-loop feedback controller torque set point to generate an electric machine torque. The electric machine (e.g., 208 of FIG. 2) is commanded to generate the commanded electric machine torque.

The method of FIGS. 7 and 8 provide for a method for shifting gears of a transmission, comprising: via a controller, adjusting an output of one or more torque sources to synchronize an input speed of an on-coming clutch to an output speed of the on-coming clutch while adjusting a torque capacity of the on-coming clutch and/or one or more other clutches to generate a requested transmission torque output during a gear shift of the transmission. In a first example, the method includes where the gear shift is an upshift or a downshift, and where adjusting the output of the one or more torque source is performed during a torque transfer phase of the gear shift. In a second example that may include the first example, the method includes where the torque transfer phase is preceded by a clutch speed synchronization phase during the gear shift. In a third example that may include one or both of the first and second examples, the method further comprises adjusting a torque capacity of the on-coming clutch after the torque transfer phase to meet a requested or target transmission output torque. In a fourth example that may include one or more of the first through third examples, the method further comprises adjusting a torque capacity of an off-going clutch to meet the requested or target transmission output torque prior to the torque transfer phase. In a fifth example that may include one or more of the first through fourth examples, the method further comprises adjusting the torque of the one or more torque sources to meet an inertial acceleration target during the clutch speed synchronization phase. In a sixth example that may include one or more of the first through fifth examples, the method includes where the one or more torque sources are adjusted during the torque transfer phase to maintain a target transmission output torque. In a seventh example that may include one or more of the first through sixth examples, the method further comprises following the torque transfer phase with a clutch speed synchronization phase during the gear shift.

The method of FIGS. 7 and 8 also provides for a method for shifting gears of a transmission, comprising: via a controller, adjusting an order of clutch phases for a transmission gear shift according to a sign of a clutch torque; and via the controller, commanding an electric machine and a clutch according to the order of clutch phases for the transmission gear shift. In a first example, the method includes where the order of clutch phases includes a clutch filling phase, torque transfer phase, and a clutch speed synchronization phase. In a second example that may include the first example, the method includes where the order of clutch phases includes where the clutch filling phase is before the torque transfer phase and the torque transfer phase is before the clutch speed synchronization phase. In a third example that may include one or both of the first and second examples, the method includes where the order of clutch phases includes where the clutch filling phase is before the clutch speed synchronization phase and the clutch speed synchronization phase is before the torque transfer phase. In a fourth example that may include one or both of the first through third examples, the method includes where the electric machine is commanded to a torque, the torque based on an off-going gear ratio, an on-coming gear ratio, and a transmission inertia.

Referring now to FIG. 9, a stick diagram 900 of a portion of a transmission is shown. The stick diagram 900 includes a torque source 902, which may be an electric machine that is similar to electric machine 208 or engine 12 of FIG. 3. The torque source is coupled to the transmission via an input shaft 920. The transmission's input inertia is illustrated at 904 and the transmission input shaft is coupled to a first intermediate shaft or lay shaft 921 and a second intermediate shaft or lay shaft 922 via a first gear ratio input gear 906 and a second ratio input gear 912. A first clutch 908 is arrange along the first intermediate shaft 921 and a second clutch 914 is arranged alone the second intermediate shaft 922. The first intermediate shaft 921 and the second intermediate shaft 922 are coupled to the transmission output shaft 923 via first gear ratio output gear 910 and a second ratio output gear 916. The first gear ratio may be engaged via closing first clutch 908 while second clutch 914 is open. The second gear ratio may be engaged via closing second clutch 914 while first clutch 908 is open.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other engine hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for case of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. One or more of the method steps described herein may be omitted if desired.

It will be appreciated that the configurations and routines disclosed herein are exemplary in nature, and that these specific examples are not to be considered in a constrained sense, because numerous variations are possible. For example, the above technology can be applied to powertrains that include different types of torque sources including different types of electric machines and transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for shifting gears of a transmission, comprising:
via a controller, adjusting an output of one or more torque sources to synchronize an input speed of an on-coming clutch to an output speed of the on-coming clutch while adjusting a torque capacity of the on-coming clutch and/or one or more other clutches to generate a requested transmission torque output during a gear shift of the transmission.

2. The method of claim 1, where the gear shift is an upshift or a downshift, and where adjusting the output of the one or more torque sources is performed during a torque transfer phase of the gear shift.

3. The method of claim 2, further comprising following the torque transfer phase with a clutch speed synchronization phase during the gear shift.

4. The method of claim 2, further comprising preceding the torque transfer phase with a clutch speed synchronization phase during the gear shift.

5. The method of claim 4, further comprising adjusting a torque capacity of the on-coming clutch after the torque transfer phase to meet a requested or target transmission output torque.

6. The method of claim 5, further comprising adjusting a torque capacity of an off-going clutch to meet the requested or target transmission output torque prior to the torque transfer phase.

7. The method of claim 6, further comprising adjusting the torque of the one or more torque sources to meet an inertial acceleration target during the clutch speed synchronization phase.

8. The method of claim 7, where the one or more torque sources are adjusted during the torque transfer phase to maintain a target transmission output torque.

9. A vehicle system, comprising:
one or more torque sources;
a transmission including a plurality of gear clutches and gears;
a controller including executable instructions that cause the controller to adjust a torque output of the torque source to synchronize an input speed of a clutch included in the plurality of gear clutches with an output speed of the clutch while adjusting a pressure applied to the clutch to adjust an output torque of the transmission during a speed synchronization phase of a transmission gear shift.

10. The vehicle system of claim 9, where the torque source is an electric machine.

11. The vehicle system of claim 9, where the speed synchronization phase of the transmission gear shift is prior to a torque transfer phase of the transmission gear shift.

12. The vehicle system of claim 9, where the speed synchronization phase of the transmission gear shift follows a torque transfer phase of the transmission gear shift.

13. The vehicle system of claim 9, where the torque output of the torque source is adjusted based on a torque transferred via the clutch.

14. The vehicle system of claim 9, where the output torque of the transmission is adjustable.

15. The vehicle system of claim 9, where the pressure of the clutch is adjusted to generate a clutch torque that is equal to the target output torque of the transmission divided by a gear ratio of a respective active gear.

16. A method for shifting gears of a transmission, comprising:
via a controller, adjusting an order of clutch phases for a transmission gear shift according to a sign of a clutch torque; and
via the controller, commanding an electric machine and a clutch according to the order of clutch phases for the transmission gear shift.

17. The method of claim 16, where the order of clutch phases includes a clutch filling phase, torque transfer phase, and a clutch speed synchronization phase.

18. The method of claim 17, where the order of clutch phases includes where the clutch filling phase is before the torque transfer phase and the torque transfer phase is before the clutch speed synchronization phase.

19. The method of claim 17, where the order of clutch phases includes where the clutch filling phase is before the clutch speed synchronization phase and the clutch speed synchronization phase is before the torque transfer phase.

20. The method of claim 16, where the electric machine is commanded to a torque, the torque based on an off-going gear ratio, an on-coming gear ratio, and a transmission inertia.
